(19) United States
(12) Patent Application Publication
(10) Pub. No.: US 2015/0148456 A1
(43) Pub. Date: May 28, 2015

(54) METHOD FOR THE PRODUCTION OF SOLID ACCELERATORS FOR CONSTRUCTION MATERIAL MIXTURES

(71) Applicant: Construction Research & Technology GmbH, Trostberg (DE)

(72) Inventors: Diana Eissmann, Trostberg (DE); Jutta Karin Langlotz, Trostberg (DE); Stefan Friedrich, Garching (DE); Christoph Hesse, Ebersberg (DE)

(21) Appl. No.: 14/402,477

(22) PCT Filed: May 27, 2013
(86) PCT No.: PCT/EP2013/060817

§ 371 Date: Nov. 20, 2014

Related U.S. Application Data
(60) Provisional application No. 61/652,364, filed on May 29, 2012.

(30) Foreign Application Priority Data
May 29, 2012 (EP) 12169845.0

(51) Int. Cl. C08K 3/34; C04B 22/00

(52) U.S. Cl. CPC C08K 3/34; C04B 22/00
USPC 524/2; 524/456

(57) ABSTRACT

The present invention relates to a process for producing solid compositions comprising calcium silicate hydrate and at least one water-soluble polymer with cationic structural units, uncharged structural units and/or anionic structural units containing sulpho groups, wherein an aqueous suspension of the calcium silicate hydrate is contacted with the polymer and the mixture is dried by a drum drying process.

/

The present invention relates to a process for producing solid compositions comprising calcium silicate hydrate and at least one water-soluble cationic polymer, ampholytic polymer, uncharged polymer or anionic polymer containing sulpho groups.

Pulverulent setting accelerators for cementitious building material mixtures which are suitable in principle for use in dry mortar mixtures due to their solid state of matter are known in the prior art. Examples of such accelerators are calcium nitrate, calcium formate, calcium chloride and lithium carbonate. One disadvantage of chloride- or nitrate-containing accelerators is the adverse effects thereof on the corrosion resistance of, for example, steel-reinforced concrete. Due to national standards, there are use restrictions. Efflorescence on the surface of set building materials can likewise be a problem, especially in the case of use of calcium salts (for example calcium formate).

In many applications, there is the need to achieve even greater acceleration of setting and higher early strengths in cementitious systems, for example in mortar or concrete. The abovementioned accelerator types and other accelerators customary on the market, however, do not currently enable the person skilled in the art to achieve this aim; even with the accelerators customary on the market, a naturally undesired loss of final strength is observed, particularly at relatively high dosages. There is thus a great need to achieve higher early strengths in many applications, which is not possible with the accelerators currently known in the prior art.

Suspensions of calcium silicate hydrate (C-S--H) have been used in recent times as a highly efficient accelerator in (portland) cement-containing building material mixtures such as concrete. They enable attainment of significantly higher early strengths (6 hours) compared to the accelerators customary on the market. At the same time, essentially no decrease in the final strengths (28 days) is observed. Corresponding suspensions are described in WO 2010026155 A1. However, it is not possible for practical reasons to formulate dry mortar mixtures which comprise essentially (portland) cement as a binder with the aqueous suspensions of calcium silicate hydrate (C-S-H), since the water content would lead to an unacceptable, at least partially premature hydration of the binder.

WO 2012/072466 describes solid compositions comprising calcium silicate hydrate and at least one water-swellable polymer which can form a hydrogel. The water-swellable polymer is a superabsorbent which is water-insoluble. The water-swellable polymer which can form a hydrogel with water or aqueous solutions is selected from the group of anionic crosslinked polyelectrolytes, cationic crosslinked polyelectrolytes, ampholytic crosslinked polyelectrolytes and/or non-ionic crosslinked polymers.

In the course of production of the pulverulent setting accelerators based on C-S-H, large amounts of water have to be removed. This operation is laborious at low temperatures. At higher temperatures, there is the risk that the accelerator effect and dispersibility of the resulting solid will be impaired.

In the field of (portland) cement-containing dry mortar mixtures, and likewise for non-dry mortar applications such as concrete, there is a need for suitable, highly effective accelerators in order thus to enable a distinct rise in early strengths in dry mortar systems too, preferably without losses in the final strengths (strengths after 28 days). There is also a need for simple production of the accelerators.

It is therefore an object of the present invention to provide a process for producing the accelerators, which can be performed in a rapid and simple manner. The process is thus also to be performable at high drying temperatures and is to give rise to accelerators whose action is not adversely affected. Moreover, the accelerators are to have good dispersibility in aqueous media. The accelerators are to enable an effective rise in early strengths without adversely affecting the final strengths of the building material mixtures and are to have good compatibility with water-sensitive binders, i.e. those which set hydraulically with water, for example (portland) cement.

It has now been found that, surprisingly, this object is achieved by a process in which the drying is effected by a contact drying process.

The invention therefore relates to a process for producing solid compositions comprising calcium silicate hydrate (C-S-H) and at least one water-soluble polymer with cationic and/or uncharged structural units and/or anionic structural units containing sulpho groups, comprising the following process steps:
A) contacting an aqueous suspension, preferably suitable as a setting and hardening accelerator for (portland) cement-containing binder systems, of calcium silicate hydrate with at least one polymer having cationic and/or uncharged structural units and/or anionic structural units containing sulpho groups and
B) drying the product from step A) by a contact drying process at temperatures between 100 and 250° C., especially at temperatures between 120 and 250° C.

The drying is preferably effected with a drum drying process. The drum temperatures are preferably between 120 and 250° C., especially between 150 and 230° C. and more preferably 160 to 220° C.

It has been found that, surprisingly, the (co)polymers employed in accordance with the invention are suitable as a stabilising additive in the drying process of the calcium silicate hydrate-containing accelerator suspensions. It is therefore possible to dry the compositions particularly rapidly and effectively, even at high temperatures, by drum drying compared to other drying methods (drying in a forced-air drying cabinet, fluidised bed drying, spray drying), while substantially maintaining the activity as an accelerator and the dispersibility. In addition, drum drying can effectively dry accelerator compositions of high viscosity (preferably 10 000 to 100 000 mPa*s), in the case of which spray drying cannot be employed since the compositions are not sprayable due to the high viscosity.

Suitable stabilising additives in the drum drying process of calcium silicate hydrate-containing accelerator suspensions are cationic polymers, anionic polymers containing sulpho groups, ampholytic polymers (containing cationic structural units and anionic structural units containing sulpho groups) or uncharged polymers. These are homopolymers or copolymers (also referred to collectively as “(co)polymers” in the context of the present invention). The polymers can be prepared by free-radical (co)polymerisation of corresponding unsaturated monomers. The molecular weight M_{w} of the (co)polymers thus prepared is typically more than 100 000 g/mol, more preferably more than 300 000 g/mol.

Preference is given to solid compositions comprising calcium silicate hydrate and at least one such (co)polymer, the weight ratio of the (co)polymer to calcium silicate hydrate being from 5:1 to 1:3, preferably from 2:1 to 1:2.

In addition, as well as the stabilising additives, it is also possible to add comb polymer plasticisers as further additives to the suspension of calcium silicate hydrate to be dried. Appropriately, a calcium silicate hydrate suspension already comprising the comb polymer plasticisers is employed. Such calcium silicate hydrate suspensions are described in WO 2010/026155 A1, the comb polymer plasticisers being added as early as during the production of the calcium silicate hydrate suspensions. The weight ratio of comb polymer plasticiser to calcium silicate hydrate is from 2:1 to 1:10, preferably from 1:1 to 1:5.

With regard to the structure of the comb polymers and preparation thereof, reference is made to the full disclosure of WO 2010/026155. The comb polymers contain, by virtue of polymerisation of at least one acid monomer, a structural unit corresponding to the general formulae (Ia), (Ib), (Ic) and/or (Id) in the copolymer (the structural units of each formula may be the same or different):

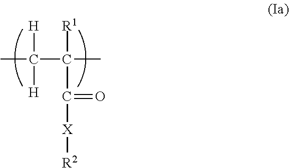

in which
R¹ is H or an unbranched or branched C₁-C₄-alkyl group;
X is NH—(CₙH₂ₙ) where n=1, 2, 3 or 4 or O—(CₙH₂ₙ) where n=1, 2, 3 or 4 or is absent;
R² is OH, PO₃H₂ or O—PO₃H₂, with the proviso that, if X is absent, R² is OH;

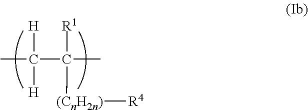

in which
R³ is H or an unbranched or branched C₁-C₄-alkyl group;
n=0, 1, 2, 3 or 4
R⁴ is PO₃H₂ or O—PO₃H₂;

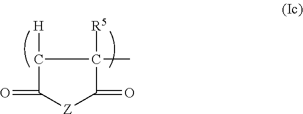

in which
R⁵ is H or an unbranched or branched C₁-C₄-alkyl group;
Z is O or NH;

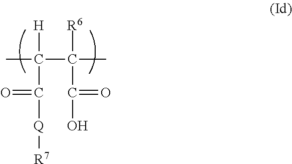

in which
R⁶ is H or an unbranched or branched C₁-C₄-alkyl group;
Q is NH and/or O;
R⁷ is H, (CₙH₂ₙ)—SO₃H where n=0, 1, 2, 3 or 4, preferably 1, 2, 3 or 4, (CₙH₂ₙ)—OH where n=0, 1, 2, 3 or 4, preferably 1, 2, 3 or 4; (CₙH₂ₙ)—PO₃H₂ where n=0, 1, 2, 3 or 4, preferably 1, 2, 3 or 4, (CₙH₂ₙ)—OPO₃H₂ where n=0, 1, 2, 3 or 4, preferably 1, 2, 3 or 4, (C₆H₄)—SO₃H, (C₆H₄)—PO₃H₂, (C₆H₄)—OPO₃H₂ or (CₘH₂ₘ)ₑ—O—(A′O)ₙ—R⁹ where m=0, 1, 2, 3 or 4, preferably 1, 2, 3 or 4, e=0, 1, 2, 3 or 4, preferably 1, 2, 3 or 4, A′=Cₓ′H₂ₓ′ where x′=2, 3, 4 or 5 or CH₂C(C₆H₅)H—, a is an integer from 1 to 350 where R⁹=unbranched or branched C₁-C₄ alkyl group.

Typically, polymerisation of the polyether macromonomer produces a structural unit in the copolymer corresponding to the general formulae (IIa), (IIb) and/or (IIc) (the structural units in each formula may be the same or different):

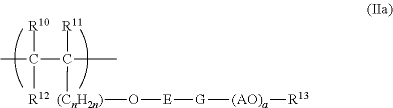

where

R¹⁰, R¹¹ and may be the same or different and are each independently H or an unbranched or branched C₁-C₄ alkyl group;

E is an unbranched or branched C₁-C₆-alkylene group, preferably a C₂-C₆-alkylene group, a cyclohexylene group, CH₂-C₆H₁₀, ortho-, meta- or para-substituted C₆H₄, or is absent;

G is O, NH or CO—NH, with the proviso that, if E is absent, G is also absent;

A may be the same or different and is CₓH₂ₓ where x=2, 3, 4 or 5 (preferably x=2) or CH₂CH(C₆H₅);

n is 0, 1, 2, 3, 4 and/or 5;

a is an integer from 2 to 350 (preferably 10-200);

R¹³ is H, an unbranched or branched C₁-C₄-alkyl group, CO—NH₂ and/or COCH₃;

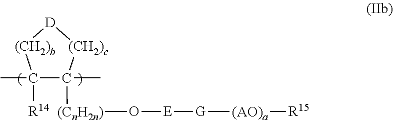

in which

R¹⁴ is H or an unbranched or branched C₁-C₄-alkyl group;

E is an unbranched or branched C₁-C₆-alkylene group, preferably a C₂-C₆-alkylene group, a cyclohexylene group, CH₂-C₆H₁₀, ortho-, meta- or para-substituted C₆H₄, or is absent;

G is absent or is O, NH or CO—NH, with the proviso that, if E is absent, G is also absent; A may be the same or different and is CₓH₂ₓ where x=2, 3, 4 or 5 or CH₂CH(C₆H₅);

n is 0, 1, 2, 3, 4 and/or 5;

a is an integer from 2 to 350;

D is absent or is NH or O, with the proviso that, if D is absent: b=0, 1, 2, 3 or 4 and c=0, 1, 2, 3 or 4, where b+c=3 or 4, and with the proviso that, if D is NH or O, b=0, 1, 2 or 3, c=0, 1, 2 or 3, where b+c=2 or 3;

R¹⁵ is H, an unbranched or branched C₁-C₄-alkyl group, CO—NH₂ or COCH₃;

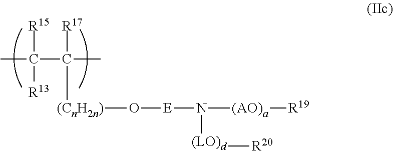

in which

R¹⁶, R¹⁷ and R¹⁸ may be the same or different and are each independently H or an unbranched or branched C₁-C₄-alkyl group;

E is an unbranched or branched C₁-C₆-alkylene group, preferably a C₂-C₆-alkylene group, a cyclohexylene group, CH₂-C₆H₁₀, ortho-, meta- or para-substituted C₆H₄, or is absent; E is preferably present;

A may be the same or different and is CₓH₂ₓ where x=2, 3, 4 or 5 or CH₂CH(C₆H₅);

n is 0, 1, 2, 3, 4 and/or 5;

L may be the same or different and is CₓH₂ₓ where x=2, 3, 4 or 5 or CH₂CH(C₆H₅);

a is an integer from 2 to 350;

d is an integer from 1 to 350;

R¹⁹ is H or an unbranched or branched C₁-C₄-alkyl group,

R²⁰ is H or an unbranched C₁-C₄-alkyl group.

In a further embodiment of the invention, polymerisation of the polyether macromonomer produces a structural unit in the polymer corresponding to the general formula (IId):

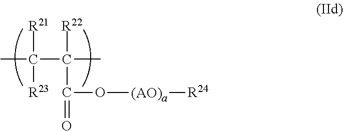

in which

R²¹, R²² and R²³ may be the same or different and are each H or an unbranched or branched C₁-C₄-alkyl group;

A is CₓH₂ₓ where x=2, 3, 4 or 5 or CH₂CH(C₆H₅); a may be the same or different and is an integer from 2 to 350;

R²⁴ is H or an unbranched or branched C₁-C₄-alkyl group, preferably a C₁-C₄-alkyl group.

The polyether macromonomer used is preferably alkoxylated isoprenol and/or alkoxylated hydroxybutyl vinyl ether and/or alkoxylated (meth)allyl alcohol and/or vinylated methyl polyalkylene glycol, in each case preferably with an arithmetic mean of 4 to 340 oxyalkylene groups. The acid monomer used is preferably methacrylic acid, acrylic acid, maleic acid, maleic anhydride, a monoester of maleic acid or a mixture of two or more of these compounds.

The invention also relates to solid compositions obtainable by the process according to the invention.

The inventive composition is in the solid state. The composition is preferably pulverulent and is preferably suitable as a setting and hardening accelerator for (portland) cement-containing binder systems. The water content in the inventive solid composition should preferably be less than 15% by weight, more preferably less than 10% by weight.

The inventive solid composition is preferably an accelerator composition.

The finely dispersed calcium silicate hydrate (C-S-H) present in the inventive solid composition may be modified by extraneous ions, such as magnesium, aluminium or sulphate.

The calcium silicate hydrate (as the reactant for further processing) may be prepared in the form of an aqueous suspension, preferably in the presence of a comb polymer plasticiser as described above; see WO 2010/026155 A1, which is fully incorporated by reference. The suspensions can preferably be prepared by a process according to any of claims 1 to 14 or 15 to 38 of WO 2010/026155 A1, by reaction of a water-soluble calcium compound with a water-soluble silicate compound in the presence of an aqueous solution which comprises the said water-soluble comb polymer suitable as a plasticiser for hydraulic binders.

Typically, this affords a suspension comprising the calcium silicate hydrate (C-S-H) in finely dispersed form. The solids content of the suspension is preferably between 5 and 35% by weight, more preferably between 10 and 30% by weight, especially preferably between 15 and 25% by weight.

The inorganic calcium silicate hydrate (C-S-H) component can be described in most cases, with regard to the composition thereof, by the following empirical formula:

a CaO, SiO₂, b Al₂O₃, c H₂O, d Z₂O, e WO

Z is an alkali metal

W is an alkaline earth metal, W preferably being an alkaline earth metal other than calcium,

| | | |
|---|---|---|
| 0.1 ≦ a ≦ 2 | preferably | 0.66 ≦ a ≦ 1.8 |
| 0 ≦ b ≦ 1 | preferably | 0 ≦ b ≦ 0.1 |
| 1 ≦ c ≦ 6 | preferably | 1 ≦ c ≦ 6.0 |
| 0 ≦ d ≦ 1 | preferably | 0 ≦ d ≦ 0.4 |
| 0 ≦ e ≦ 2 | preferably | 0 ≦ e ≦ 0.1 |

The molar ratios are more preferably selected such that the preferred ranges for a, b and e are satisfied in the above empirical formula

(0.66≦a≦1.8; 0≦b≦0.1; 0≦e≦0.1).

The calcium silicate hydrate in the inventive compositions is preferably in the form of foshagite, hillebrandite, xonotlite, nekoite, clinotobermorite, 9 Å—tobermorite (riversiderite), 11 Å tobermorite, 14 Å—tobermorite (plombierite), jennite, metajennite, calcium chondrodite, afwillite, α—C₂SH, dellaite, jaffeite, rosenhahnite, killalaite and/or suolunite, more preferably in the form of xonotlite, 9 Å-tobermorite (riversiderite), 11Å-tobermorite, 14 Å—tobermorite (plombierite), jennite, metajennite, afwillite and/or jaffeite. The molar ratio of calcium to silicon in the calcium silicate hydrate is preferably from 0.6 to 2 and more preferably from 1.0 to 1.8. The molar ratio of calcium to water in the calcium silicate hydrate is preferably 0.6 to 6, more preferably 0.6 to 2 and especially preferably 0.8 to 2.

The particle size of the calcium silicate hydrate (C-S-H) in the inventive solid compositions is preferably less than 1000 nm, more preferably less than 500 nm and especially preferably less than 200 nm, measured by light scattering with the ZetaSizer Nano instrument from Malvern.

The (co)polymer may be crosslinked, i.e. water-swellable, or uncrosslinked. It preferably does not contain any structural units which derive from monomers having more than one free-radically polymerisable, ethylenically unsaturated vinyl group and/or any other crosslinking structural units. The (co)polymer employed in accordance with the invention is thus preferably uncrosslinked and not water-swellable.

The (co)polymer employed as a stabilising additive in accordance with the invention preferably comprises the following structural units (the proportions of all structural units add up to 100 mol %):

a) 0 to 100 mol % of cationic structural units of the general formula (I)

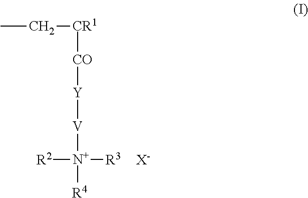

in which
R¹ is H or a methyl radical,
R² and R³ may be the same or different and are each independently H, an aliphatic hydrocarbyl radical having 1 to 20 carbon atoms (branched or unbranched, preferably methyl or ethyl radical), a cycloaliphatic hydrocarbyl radical having 5 to 8 carbon atoms (especially cyclohexyl radical) or an aryl radical having 6 to 14 carbon atoms (especially phenyl radical),
R⁴ is as defined for R² or R³ or is —(CH₂)ₓ—SO₃Mₖ, SO₃Mₖ and/or

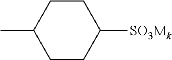

and/or

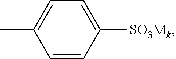

preferably methyl or ethyl,
M is a mono- or divalent metal cation, ammonium cation (NH₄⁺) or quaternary ammonium cation (NR₁R₂R₃R₄)⁺,
k is ½ and/or 1,
Y is —O—, —NH— and/or —NR²—, preferably —O—,
V is —(CH₂)ₓ—,

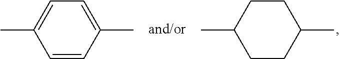

x is an integer from 1 to 6 (preferably 1 or 2),
X is a halogen atom (preferably Cl or Br) , C₁- to C₄-alkylsulphate (preferably methylsulphate) or C₁- to C₄-alkylsulphonate (preferably methylsulphonate);
b) 0 to 100 mol % of cationic structural units of the general formula (II)

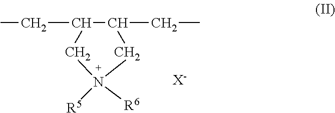

in which
R⁵, R⁶ are the same or different and are each H, an aliphatic hydrocarbyl radical having 1 to 6 carbon atoms or a phenyl radical optionally substituted by one, two or three methyl groups (preferably one methyl group),
c) 0 to 100 mol % of anionic structural units which contain sulpho groups and are of the general formula (III)

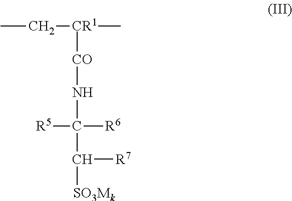

k, M, R¹, R⁵ and R⁶ are each as defined above,
R² is H, an aliphatic hydrocarbyl radical having 1 to 6 carbon atoms or a phenyl radical optionally substituted by one, two or three methyl groups (preferably one methyl group);
d) 0 to 100 mol % of structural units which contain amido groups (uncharged structural units) and are of the general formulae (IVa) and/or (IVb)

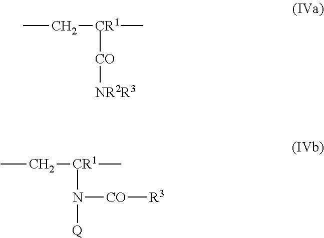

in which
Q is H or —CHR²R⁵,
R¹, R² and R³ are each as defined above, with the proviso that, in the case that Q is not hydrogen, R² and R³ in the general formula (IVb) together may be —CH₂—(CH₂)_{y}—, such that the general formula (IVb) has the following structure (IVc):

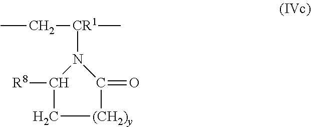

in which
R⁸ is H, a C₁- to C₄-alkyl radical, a carboxylic acid group or a carboxylate group —COOMₖ, where y is an integer from 1 to 4 (preferably 1 or 2), and R⁵, M and k are each as defined above, or
structural units derived from esters of acrylic acid or methacrylic acid with C₁-C₈-alkanols such as methanol, ethanol or 2-ethylhexanol, esters of acrylic acid or methacrylic acid with C₂-C₈-alkanediols such as glycol or 1,3-propanediol, and ethers of vinyl alcohol with C₁-C₈-alkanols such as vinyl ethyl ether or vinyl butyl ether.

The structural units derived from the esters and ethers mentioned are especially present together with the units of the formulae (IVa), (IVb) and/or (IVc), preferably in a molar ratio of 1:2 to 1:20, especially 1:3 to 1:10.

The compositions of the invention may thus be polymers formed from structural units of one kind. In that case, they are homopolymers. They may also be formed from different structural units. In that case, they are copolymers. These may contain exclusively cationic structural units, or exclusively uncharged structural units, or exclusively anionic structural units containing sulpho groups. The copolymers may also be formed such that they contain anionic structural units containing sulpho groups and cationic structural units, anionic structural units containing sulpho groups and uncharged structural units, cationic and uncharged structural units or anionic structural units containing sulpho groups, cationic and uncharged structural units.

The structural unit a) preferably originates from the polymerisation of one or more of the monomer species [2-(acryloyloxy)ethyl]trimethylammonium chloride, [2-(acryloylamino)-ethyl]trimethylammonium chloride, [2-(acryloyloxy)ethyl]trimethylammonium metho-sulphate, [2-(methacryloyloxy)ethyl]trimethylammonium chloride and methosulphate, [3 -(acryloylamino)propyl]trimethylammonium chloride, [3 -(methacryloylamino)propyl]-trimethylammonium chloride, N-(3-sulphopropyl)-N-methyacryloxyethyl-N′-N-dimethylammonium betaine, N-(3-sulphopropyl)-N-methyacrylamidopropyl-N,N-dimethylammonium betaine and/or 1 -(3 -sulphopropyl)-2-vinylpyridinium betaine. Preference is given to [2-(acryloyloxy)ethyl]trimethyl-ammonium chloride, [2-(acryloylamino)ethyl]trimethylammonium chloride, [2-(methacryloyloxy)-ethyl]trimethylammonium chloride, [3-(acryloylamino)propyl]-trimethylammonium chloride and [3-(methacryloylamino)propyl]trimethylammonium chloride. Preference is given to [2-(methacryloyloxy)ethyl]trimethylammonium chloride, [3-(acryloylamino)-propyl]trimethylammonium chloride and [3 -(methacryloylamino)-propyl]-trimethylammonium chloride.

The structural unit b) preferably derives from N,N-dimethyldiallylammonium chloride and/or N,N-diethyldiallylammonium chloride.

The structural unit c) preferably derives from monomers such as 2-acrylamido-2-methyl-propanesulphonic acid, 2-methacrylamido-2-methylpropanesulphonic acid, 2-acrylamidobutanesulphonic acid, 3-acrylamido-3-methylbutanesulphonic acid and/or 2-acrylamido-2,4,4-trimethylpentanesulphonic acid. Particular preference is given to 2-acrylamido-2-methylpropanesulphonic acid (ATBS).

In general, the structural unit d) goes from the polymerisation of one or more of the monomer species acrylamide, methacrylamide, N-methylacrylamide, N,N-dimethylacrylamide, N-ethylacrylamide, N-cyclohexylacrylamide, N-benzylacrylamide, N-methylolacrylamide, N-tert-butylacrylamide etc. Examples of monomers as the basis of the structure (IVb) are N-methyl-N-vinylformamide, N-vinylformamide, N-methyl-N-vinylacetamide, N-vinylacetamide, N-vinylpyrrolidone, N-vinylcaprolactam and/or N-vinylpyrrolidone-5-carboxylic acid, forth. Preference is given to acrylamide, methacrylamide and/or N,N-dimethylacrylamide.

When the polymer used in accordance with the invention is a copolymer, this may have the following structure:
a) 5 to 90 mol %, preferably 10 to 70 mol %, of structural units of the general formula (I) and 10 to 95 mol %, preferably 30 to 90 mol %, of structural units of the general formula (II), (III), (IVa), (IVb) and/or (IVc);
b) 5 to 90 mol %, preferably 10 to 70 mol %, of structural units of the general formula (II) and 10 to 95 mol %, preferably 30 to 90 mol %, of structural units of the general formula (III), (IVa), (IVb), and/or (IVc);
c) 2 to 95 mol %, preferably 5 to 90 mol %, especially 10 to 70 mol %, of structural units of the general formula (III) and 5 to 98 mol %, preferably 10 to 95 mol %, especially 30 to 90 mol %, of structural units of the general formula (IVa), (IVb), and/or (IVc);
d) 5 to 90 mol %, preferably 10 to 70 mol %, of structural units of the general formula (III) and 10 to 95 mol %, preferably 30 to 90 mol %, of structural units of the general formula (IVa), (IVb), and/or (IVc);
e) 5 to 90 mol %, preferably 10 to 70 mol %, of structural units of the general formula (IVa) and 10 to 95 mol %, preferably 30 to 90 mol %, of structural units of the general formula (IVb), and/or (IVc);
f) 5 to 90 mol %, preferably 10 to 70 mol %, of structural units of the general formula (IVb) and 10 to 95 mol %, preferably 30 to 90 mol %, of structural units of the general formula (IVc).

(The expression “and/or” in this context means that the structural unit stated first may be present alone or in combination with one or more of the other structural units.)

Preference is given to copolymers with the structure specified in a) and c).

The polymers employed in accordance with the invention may also contain further monomers in polymerised form. Examples of such monomers are acrylic acid, methacrylic acid, maleic acid, itaconic acid, esters of acrylic acid or methacrylic acid with C₁-C₈-alkanols such as methanol, ethanol or 2-ethylhexanol, esters of acrylic acid or methacrylic acid with C₂-C₈-alkanediols such as glycol or 1,3-propanediol, etc. These monomers may be polymerised in amounts of 0.1 to 30 mol % (the proportions of all monomers add up to 100 mol %). In the case of monomers containing carboxyl groups, however, not more than 20 mol % are polymerised.

The aqueous suspension of calcium silicate hydrate which is preferentially suitable as a setting and hardening accelerator for (portland) cement-containing binder systems and is employed in process stage A) is appropriately prepared by reacting a water-soluble calcium compound with a water-soluble silicate compound, the water-soluble calcium compound being reacted with the water-soluble silicate compound in the presence of an aqueous solution preferably comprising a water-soluble comb polymer suitable as a plasticiser for hydraulic binders.

The aqueous suspension of calcium silicate hydrate preferentially suitable as a setting and hardening accelerator for (portland) cement-containing binder systems is appropriately prepared by reacting a water-soluble calcium compound with a water-soluble silicate compound, the water-soluble calcium compound being reacted with the water-soluble silicate compound in the presence of an aqueous solution which preferably comprises a (co)polymer having carboxylic acid groups and/or carboxylate groups and sulphonic acid groups and/or sulphonate groups, the molar ratio of the number of carboxylic acid groups and/or carboxylate groups to the sulphonic acid groups and/or sulphonate groups being from 1/20 to 20/1, preferably 1/5 to 5/1, more preferably 1/2 to 2/1.

The calcium silicate hydrate preferably does not originate from a hydration reaction of (portland) cement with water.

The drying in stage B) is effected preferably at temperatures (drum temperature) between 120 and 250° C., preferably between 150 and 230° C. The drying apparatuses employed are customary apparatuses for contact drying, especially drum drying apparatuses. Such apparatuses are described, for example, in Ullmann's Encyclopedia of Industrial Chemistry, 5th ed., Vol. B2, 4-25.

According to the invention, there may follow a process step C) which comprises the grinding of the dried product from process step B) to a powder.

The invention also relates to the use of the inventive compositions as setting accelerators in building material mixtures comprising (portland) cement, slag sand, fly ash, silica dust, metakaolin, natural pozzolans, burnt oil shale and/or calcium aluminate cement or in building material mixtures comprising (portland) cement and calcium sulphate-based binders, preferably in building material mixtures comprising essentially (portland) cement as a hydraulic binder. The building material mixtures preferably comprise water, more preferably in a weight ratio of water to powder (W/P) of 0.2:0.8, “powder” being understood to mean the sum total of the binders present in the building material mixture, preferably (portland) cement.

The invention also relates to the use of the inventive compositions as grinding aids in the production of (portland) cement.

The invention further relates to building material mixtures comprising the inventive compositions and (portland) cement, slag sand, fly ash, silica dust, metakaolin, natural pozzolans, burnt oil shale and/or calcium aluminate cement, or to building material mixtures comprising the inventive compositions, (portland) cement and calcium sulphate-based binders, preferably building material mixtures comprising essentially (portland) cement as a hydraulic binder.

Preference is given to inventive compositions which do not contain any (portland) cement. Particular preference is given to inventive compositions which do not contain any (portland) cement which has come into contact with water. (Portland) cement which has come into contact with water shall also be understood to mean dried mixtures of (portland) cement and water which may contain a small water content.

The monomers are preferably (co)polymerized by free-radical bulk, solution, gel, emulsion, dispersion or suspension polymerisation. Since the inventive products are hydrophilic (co)polymers, polymerisation in the aqueous phase, polymerisation in inverse emulsion, or polymerisation in inverse suspension is preferred. In particularly preferred embodiments, the reaction is effected as a solution polymerisation, gel polymerisation or as an inverse suspension polymerisation in organic solvents.

In a particularly preferred embodiment, the preparation of the (co)polymers can be performed as an adiabatic polymerisation, and can be initiated either with a redox initiator system or with a photoinitiator. In addition, a combination of both initiation variants is possible. The redox initiator system consists of at least two components, an organic or inorganic oxidizing agent and an organic or inorganic reducing agent. Frequently, compounds with peroxide units are used, for example inorganic peroxides such as alkali metal and ammonium persulphate, alkali metal and ammonium perphosphates, hydrogen peroxide and salts thereof (sodium peroxide, barium peroxide), or organic peroxides such as benzoyl peroxide, butyl hydroperoxide, or peracids such as peracetic acid. In addition, it is also possible to use other oxidizing agents, for example potassium permanganate, sodium or potassium chlorate, potassium dichromate, etc. The reducing agents used may be sulphur compounds such as sulphites, thiosulphates, sulphinic acid, organic thiols (for example ethylmercaptan, 2-hydroxyethanethiol, 2-mercaptoethylammonium chloride, thioglycolic acid) and others. In addition, ascorbic acid and low-valency metal salts are possible [copper(I); manganese(II); iron(II)]. It is also possible to use phosphorus compounds, for example sodium hypophosphite.

In the case of a photopolymerisation, it is initiated with UV light which brings about the decomposition of a photoinitiator. The photoinitiator used may, for example, be benzoin and benzoin derivatives, such as benzoin ether, benzil and derivatives thereof, such as benzil ketals, aryldiazonium salts, azoinitiators, for example 2,2′-azobis(isobutyronitrile), 2,2′-azobis(2-amidinopropane) hydrochloride and/or acetophenone derivatives.

The proportion by weight of the oxidizing and reducing components in the case of redox initiator systems is preferably in each case in the range between 0.00005 and 0.5% by weight, more preferably in each case between 0.001 and 0.1% by weight. For photoinitiators, this range is preferably between 0.001 and 0.1% by weight, more preferably between 0.002 and 0.05% by weight. The percentages by weight mentioned for oxidizing and reducing components and photoinitiators are each based on the mass of the monomers used for copolymerisation.

The (co)polymerisation is preferably performed in aqueous solution, preferably in concentrated aqueous solution, batchwise in a polymerisation vessel (batch process) or continuously by the “continuous belt” method described in U.S. Pat. No. 4,857,610. A further possibility is polymerisation in a continuous or batchwise kneading reactor. The operation is initiated typically at a temperature between −20 and 20° C., preferably between -10 and 10° C., and performed at atmospheric pressure without external supply of heat, and a maximum end temperature of 50 to 150° C. depending on the monomer content is obtained as a result of the heat of polymerisation. The end of the (co)polymerisation is generally followed by comminution of the polymer. In the case of performance on the laboratory scale, the comminuted polymer is dried in a forced-air drying cabinet at 70 to 180° C., preferably at 80 to 150° C. On the industrial scale, the drying can also be effected continuously, for example on a belt dryer or in a fluidised bed dryer.

In a further preferred embodiment, the (co)polymerisation is effected as an inverse suspension polymerisation of the aqueous monomer phase in an organic solvent. The procedure here is preferably to polymerize the monomer mixture which has been dissolved in water and optionally neutralised in the presence of an organic solvent in which the aqueous monomer phase is insoluble or sparingly soluble. Preference is given to working in the presence of “water in oil” emulsifiers (W/O emulsifiers) and/or protective colloids based on low or high molecular weight compounds, which are used in proportions of 0.05 to 5% by weight, preferably 0.1 to 3% by weight, based on the monomers. The W/O emulsifiers and protective colloids are also referred to as stabilizers. It is possible to use customary compounds known as stabilizers in inverse suspension polymerisation technology, such as hydroxypropylcellulose, ethylcellulose, methylcellulose, cellulose acetate butyrate mixed ethers, copolymers of ethylene and vinyl acetate and of styrene and butyl acrylate, polyoxyethylene sorbitan monooleate, laurate and stearate, and block copolymers formed from propylene oxide and/or ethylene oxide.

The organic solvents used may, for example, be linear aliphatic hydrocarbons such as n-pentane, n-hexane, n-heptane, branched aliphatic hydrocarbons (isoparaffins), cycloaliphatic hydrocarbons such as cyclohexane and decalin, and aromatic hydrocarbons such as benzene, toluene and xylene. Additionally suitable are alcohols, ketones, carboxylic esters, nitro compounds, halogenated hydrocarbons, ethers and many other organic solvents. Preference is given to those organic solvents which form azeotropic mixtures with water, particular preference to those which have a maximum water content in the azeotrope.

The (co)polymers are initially obtained as finely divided aqueous droplets in the organic suspension medium and are preferably isolated by removing the water as solid spherical particles in the organic suspension medium. Removal of the suspension medium and drying leaves a pulverulent solid. Inverse suspension polymerisation is known to have the advantage that variation of the polymerisation conditions allows the particle size distribution of the powders to be controlled, thus usually allowing an additional process step (grinding operation) to establish the particle size distribution to be avoided.

The inventive solid compositions are preferably used in dry mortar mixtures, especially in powder form.

The invention also relates to the use of the inventive compositions as a grinding aid in the production of (portland) cement, preferably in the grinding of the clinker or clinker blend to give the (portland) cement. Clinker blend is preferably understood to mean a mixture of clinker and substitutes such as slag, fly ash and/or pozzolans. The compositions are used in amounts of 0.001% by weight to 5% by weight, preferably in amounts of 0.01% by weight to 0.5% by weight, based in each case on the clinker or clinker blend to be ground. It is possible to use the inventive compositions as grinding aids in ball mills or else in vertical mills. The inventive compositions can be used as grinding aids alone or else in combination with other grinding aids, for example mono-, di-, tri- and polyglycols, polyalcohols (for example glycerol of various purities, for example from biodiesel production), amino alcohols (e.g. MEA, DEA, TEA, TIPA, THEED, DIHEIPA), organic acids and/or salts thereof (e.g. acetic acid and/or salts thereof, formates, gluconates), amino acids, sugars and residues from sugar production (e.g. molasses, vinasses), inorganic salts (chlorides, fluorides, nitrates, sulphates) and/or organic polymers (e.g. polyether carboxylates (PCEs)). It has been found that especially the early strengths of the (portland) cement thus produced can be improved. Equally suitable as grinding aids in the production of (portland) cement from clinker or clinker blends are the accelerator suspensions (in liquid form) disclosed in WO 2010026155 A1 and the pulverulent accelerators disclosed in WO 2010026155 A1. These grinding aids can likewise be used alone or in combination with the aforementioned list of grinding aids. Again, it is possible to use either a ball mill or a vertical mill.

Preference is given to building material mixtures comprising solid compositions of calcium silicate hydrate and at least one inventive (co)polymer and (portland) cement, slag sand, fly ash, silica dust, metakaolin, natural pozzolans, burnt oil shale and/or calcium aluminate cement, said solid composition not comprising any (portland) cement which has come into contact with water. (Portland) cement which has come into contact with water shall also be understood to mean mixtures of (portland) cement and water which have now dried, and which may comprise a preferably small water content.

The building material mixtures may comprise, as additional additives, defoamers, air pore formers, fillers, redispersible polymer powders, retardants, thickeners, water retention agents and/or wetting agents.

Production Examples

Polymer 1 (Cationic)

A 21 polymerization reactor with stirrer, reflux condenser, thermometer and inert gas connection was charged with 592.6 g of water. With stirring 400 g (0.91 mol) of [3-(methacrylamido)propyl]trimethylammonium chloride (50% by weight aqueous solution) were added, and then the pH was adjusted to 7.0. The solution was rendered inert by being flushed with nitrogen for 30 minutes and was heated to 70° C. Subsequently, in succession, 1.2 g of tetraethylenepentamine (20% by weight aqueous solution) and 8.0 g of sodium peroxodisulphate (20% by weight aqueous solution) were added in order to initiate the polymerization. The batch was stirred at 70° C. for 2 hours in order to complete the polymerization.

Polymer 2 (Ampholytic)

A 21 polymerization reactor with stirrer, reflux condenser, thermometer and inert gas connection was charged with 592.6 g of water. With stirring 356.3 g (0.81 mol) of [3-(methacrylamido)propyl]trimethylammonium chloride (50% by weight aqueous solution) and 43.7 g (0.10 mol) of the sodium salt of 2-acrylamido-2-methylpropanesulphonic acid (50% by weight aqueous solution) were added, and then the pH was adjusted to 7.0. The solution was rendered inert by being flushed with nitrogen for 30 minutes and was heated to 70° C. Subsequently, in succession, 1.2 g of tetraethylenepentamine (20% by weight aqueous solution) and 8.0 g of sodium peroxodisulphate (20% by weight aqueous solution) were added in order to initiate the polymerization. The batch was stirred at 70° C. for 2 hours in order to complete the polymerization.

Polymer 3 (Anionic)

A 21 polymerization reactor with stirrer, reflux condenser, thermometer and inert gas connection was charged with 791.0 g of water. With stirring 105.0 g (0.23 mol) of the sodium salt of 2-acrylamido-2-methylpropanesulphonic acid (50% by weight aqueous solution) and 48.0 g (0.48 mol) of N,N-dimethylacrylamide were added, and then the pH was adjusted to 7.0. The solution was rendered inert by being flushed with nitrogen for 30 minutes and was heated to 70° C. Subsequently, in succession, 0.9 g of tetraethylenepentamine (20% by weight aqueous solution) and 6.5 g of sodium peroxodisulphate (20% by weight aqueous solution) were added in order to initiate the polymerization. The batch was stirred at 70° C. for 2 hours in order to complete the polymerization.

Production Example for Accelerator Powder:

The calcium silicate hydrate-containing powders were produced by mixing one or else more than one more than one stabilising additive (as an aqueous solution or solid) with the C-S-H suspension DP1. DP1 is an aqueous calcium silicate hydrate suspension which has been produced from calcium acetate and Na₂SiO₃ according to WO 2010026155 A1 and /contains 5.4% by weight of MVA®2500 (product from BASF Construction Polymers GmbH), solids content 45.4% by weight. DP1 contains 1.85% by weight of CaO and 1.97% by weight of SiO₂. The figures given above in % by weight are each based on the overall aqueous suspension.

A vessel was initially charged with the C-S-H suspension DP1 which was stirred with a finger stirrer. The appropriate amount (see Table 1) of the particular stabilising additive was added cautiously (as an aqueous solution or solid). The resulting mixture was stirred for about a further 30 min and then dried with a drum drier (drum temperature 200° C.). The dried powder was subsequently converted to a pulverulent state with the aid of a centrifugal mill. The mean particle diameter of the polymer powder was 40 to 60 μm. The particle size is determined to the standard edana 420.2-02.

Use Examples

Table 1 contains example compositions of the inventive powders.

TABLE 1
Inventive compositions and comparative examples

| | Starting weight of water-soluble | Amount of C-S-H |
|---|---|---|
| | copolymer | suspension DP1 |
| Powder 1 | 12.35 g Magnafloc ® LT37 (40.5% | 131.9 ml |
| | solids)¹ | |
| Powder 2 | 24.7 g Magnafloc ® LT37 (40.5% solids)¹ | 131.9 ml |
| Powder 3 | 5 g Starvis ® 2006 F² | 131.9 ml |
| Powder 4 | 10 g Starvis ® 2006 F² | 131.9 ml |
| Powder 5 | 5 g Starvis ® 4500 F³ | 131.9 ml |
| Powder 6 | 10 g Starvis ® 4500 F³ | 131.9 ml |
| Powder 7 | 25 g polymer 1 (20% solids) | 131.9 ml |
| Powder 8 | 25 g polymer 1 (20% solids) | 131.9 ml |
| | 5.5 g MVA ® 2500 (45.4% solids)⁴ | |
| Powder 9 | 25 g polymer 2 (20% solids) | 131.9 ml |
| Powder 10 | 25 g polymer 2 (20% solids) | 131.9 ml |
| | 5.5 g MVA ® 2500 (45.4% solids)⁴ | |
| Powder 11 | 25 g polymer 3 (20% solids) | 131.9 ml |

¹Magnafloc ® LT37 (polydiallyldimethylammonium chloride) is a product from BASF SE.
²Starvis ® 2006 F is an ampholytic polymer product from BASF Construction Polymers GmbH.
³Starvis ® 4500 F is an anionic polymer product containing sulpho groups from BASF Construction Polymers GmbH.
⁴MVA 2500 ® is an anionic comb polymer plasticizer product from BASF Construction Polymers GmbH.

In order to test the efficacy of the inventive powders obtained, 6-hour strengths were determined in a standard mortar (prisms analogous to DIN EN 196-1, produced in Styropor prism moulds).

Standard mortar formulation: 225 g water
1350 g standard sand
450 g CEM I 52.5 R Milke

As reference tests, the following mixtures were tested:
Comparative 1: blank without addition of accelerator
Comparative 2: with aqueous C-S-H suspension (DP1)
Comparative 3: with a powder obtained from the C-S-H suspension DP 1 by drying at 200° C. on a drum drier without any additives.

TABLE 2
Flexural tensile strengths and compressive strengths

| | | Flexural tensile | Compressive |
|---|---|---|---|
| | | strength | strength |
| | Dosage | [N/mm²] | [N/mm²] |
| | [g] | after 6 h | after 6 h |
| Comparative 1 | — | not measureable, | not measureable, |
| (blank without | | prism falls apart | prism falls apart |
| addition of | | on demoulding | on demoulding |
| accelerator) | | | |
| Comparative 2¹ | 59.1 | 3.4 | 14.3 |
| (aqueous C-S-H | | | |
| suspension DP1) | | | |
| Comparative 3 | 4.7 | 0.2 | 0.8 |
| (C-S-H suspension | | | |
| DP1 drum-dried at | | | |
| 200° C.) | | | |
| Powder 1 | 7.0 | 2.0 | 7.2 |
| Powder 2 | 9.2 | 3.0 | 10.8 |
| Powder 3 | 7.0 | 1.5 | 4.7 |
| Powder 4 | 9.2 | 2.9 | 11.3 |
| Powder 5 | 7.0 | 2.5 | 9.3 |
| Powder 6 | 9.2 | 3.8 | 14.2 |
| Powder 7 | 7.0 | 3.8 | 1.3 |
| Powder 8 | 8.1 | 2.1 | 7.1 |
| Powder 9 | 7.0 | 3.7 | 1.2 |
| Powder 10 | 8.1 | 2.0 | 6.5 |
| Powder 11 | 7.0 | 4.1 | 12.4 |

¹The mixing water in this mortar mixture was reduced by 54.4 g to establish the same water/cement ratio.

When the inventive powders were used, it was shown that the activity of the inventive powders as accelerators in the course of drying is much improved compared to reference test 3 with the C-S-H powder dried without polymer addition, i.e. the 6h strengths are much higher.

1. Process for producing solid compositions comprising calcium silicate hydrate and at least one water-soluble polymer with cationic structural units, uncharged structural units and/or anionic structural units containing sulpho groups, comprising the following process steps:
A) contacting an aqueous suspension of calcium silicate hydrate with at least one polymer having cationic structural units, uncharged structural units and/or anionic structural units containing sulpho groups and
B) drying the product from step A) by a drum drying process at temperatures between 100 and 250° C.

2. The process according to claim 1, wherein the drying in stage B) is effected at temperatures between 150 and 230° C.

3. The process according to claim 1, wherein one or more drum driers arranged in series are used.

4. The process according to claim 1, wherein the (co)polymer comprises the following structural units:
a) 0 to 100 mol % of cationic structural units of the general formula (I) 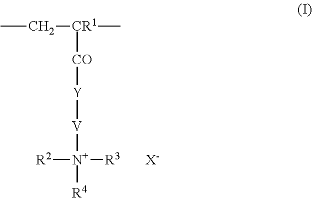
in which
R¹ is H or a methyl radical,
R² and R³ may be the same or different and are each independently H, an aliphatic hydrocarbyl radical having 1 to 20 carbon atoms, a cycloaliphatic hydrocarbyl radical having 5 to 8 carbon atoms or an aryl radical having 6 to 14 carbon atoms,
R⁴ is as defined for R² or R³ or is —(CH₂)ₓ—SO₃Mₖ, SO₃Mₖ or 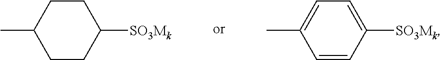
M is a mono- or divalent metal cation, ammonium cation (NH₄⁺) or quaternary ammonium cation (NR₁R₂R₃R₄)⁺,
k is ½ or 1,
Y is —O—, —NH— or —NR²-,
V is —(CH₂)ₓ—, 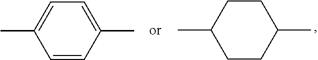
x is an integer from 1 to 6,
X is a halogen atom, C₁- to C₄-alkylsulphate or C₁- to C₄-alkylsulphonate;
b) 0 to 100 mol % of cationic structural units of the general formula (II) 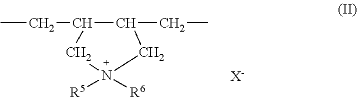
in which
R⁵, R⁶ are the same or different and are each H, an aliphatic hydrocarbyl radical having 1 to 6 carbon atoms or a phenyl radical optionally substituted by one, two or three methyl groups,
c) 0 to 100 mol % of anionic structural units which contain sulpho groups and are of the general formula (III) 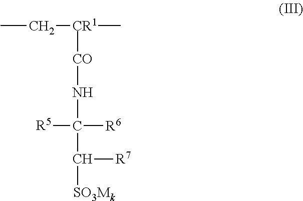
in which
k, M, R′, R⁵ and R⁶ are each as defined above,
R⁷ is H, an aliphatic hydrocarbyl radical having 1 to 6 carbon atoms or a phenyl radical optionally substituted by one, two or three methyl groups;
d) 0 to 100 mol % of structural units which contain amido groups and are of the general formulae (IVa) and/or (IVb) 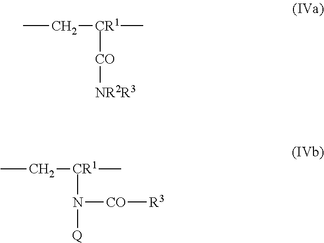
in which
Q is H or —CHR²R⁵,
R¹ , R² and R³ are each as defined above, with the proviso that, in the case that Q is not hydrogen, R² and R³ in the general formula (IVb) together may be —CH₂—(CH₂)_{y}—, such that the general formula (IVb) has the following structure (IVc): 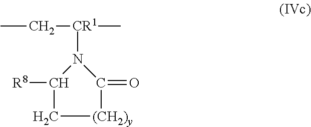
in which
R⁸ is H, a C₁- to C₄-alkyl radical, a carboxylic acid group or a carboxylate group —COOMₖ, where y is an integer from 1 to 4, and
R⁵, M and k are each as defined above.

5. The process according to claim 4, wherein the polymer has a composition selected from:
5 to 90 mol % of structural units of the general formula (I) and 10 to 95 mol % of structural units of the general formula (II), (III), (IVa), (IVb) and/or (IVc); and
2 to 95 mol % of structural units of the general formula (III) and 5 to 98 mol % of structural units of the general formula (IVa), (IVb) and/or (IVc).

6. The process according to claim 4, wherein the polymer has a composition selected from:
10 to 70 mol % of structural units of the general formula (I) and 30 to 90 mol % of structural units of the general formula (II), (III), (IVa), (IVb) and/or (IVc); and
5 to 90 mol % of structural units of the general formula (III) and 10 to 95 mol % of structural units of the general formula (IVa), (IVb) and/or (IVc).

7. The process according to claim 1, wherein the polymer has a molecular weight of more than 100 000 g/mol.

8. The process according to claim 1, wherein the weight ratio of polymer to calcium silicate hydrate is from 5:1 to 1:3.

9. The process according to claim 1, wherein an uncrosslinked polymer is used.

10. The process according to claim 1, wherein a water-swellable polymer is used.

11. The process according to claim 1, wherein a comb polymer plasticiser is additionally used in step (A).

12. The process according to claim 1, wherein the aqueous suspension of calcium silicate hydrate is prepared by reacting a water-soluble calcium compound with a water-soluble silicate compound.

13. Solid composition obtainable by a process according to claim 1.

14. Solid composition comprising calcium silicate hydrate and at least one uncrosslinked water-soluble polymer with cationic structural units, uncharged structural units and/or anionic structural units containing sulpho groups.

15. The solid composition according to claim 14, wherein the (co)polymer comprises the following structural units:
a) 0 to 100 mol % of cationic structural units of the general formula (I) 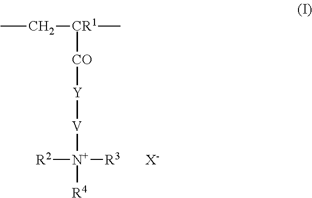
in which
R¹ is H or a methyl radical,
R² and R³ may be the same or different and are each independently H, an aliphatic hydrocarbyl radical having 1 to 20 carbon atoms, a cycloaliphatic hydrocarbyl radical having 5 to 8 carbon atoms or an aryl radical having 6 to 14 carbon atoms,
R⁴ is as defined for R² or R³ or is —(CH₂)ₓ—SO₃Mₖ, SO₃Mₖ or 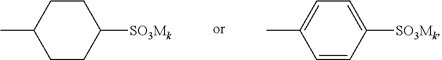
M is a mono- or divalent metal cation, ammonium cation (NH₄⁺) or quaternary ammonium cation (NR₁R₂R₃R₄)⁺,
k is ½ or 1,
Y is —O—, —NH— or —NR²—, 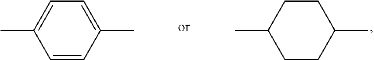
V is —(CH₂)ₓ—,
x is an integer from 1 to 6,
X is a halogen atom, C₁- to C₄-alkylsulphate or C₁- to C₄-alkylsulphonate;
b) 0 to 100 mol % of cationic structural units of the general formula (II) 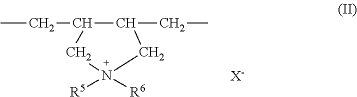
in which
R⁵, R⁶ are the same or different and are each H, an aliphatic hydrocarbyl radical having 1 to 6 carbon atoms or a phenyl radical optionally substituted by one, two or three methyl groups,
c) 0 to 100 mol % of anionic structural units which contain sulpho groups and are of the general formula (III) 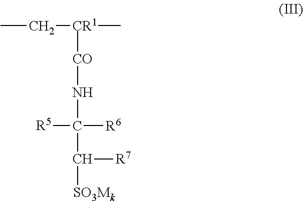
in which
k, M, R¹, R⁵ and R⁶ are each as defined above,
R⁷ is H, an aliphatic hydrocarbyl radical having 1 to 6 carbon atoms or a phenyl radical optionally substituted by one, two or three methyl groups;
d) 0 to 100 mol % of structural units which contain amido groups and are of the general formulae (IVa) and/or (IVb) 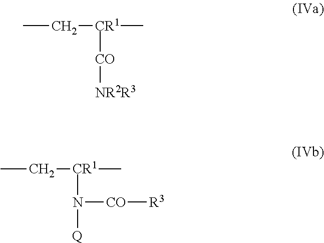
in which
Q is H or —CHR²R⁵,
R¹, R² and R³ are each as defined above, with the proviso that, in the case that Q is not hydrogen, R² and R³ in the general formula (IVb) together may be —CH₂—(CH₂)_{y}-, such that the general formula (IVb) has the following structure (IVc): 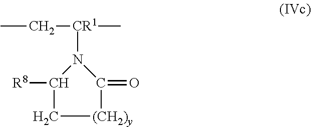
in which
R⁸ is H, a C₁- to C₄-alkyl radical, a carboxylic acid group or a carboxylate group —COOMₖ, where y is an integer from 1 to 4, and
R⁵, M and k are each as defined above.

16. The solid composition according to claim 15, wherein the polymer has a composition selected from:
5 to 90 mol % of structural units of the general formula (I) and 10 to 95 mol % of structural units of the general formula (II), (III), (IVa), (IVb) and/or (IVc); and
2 to 95 mol % of structural units of the general formula (III) and 5 to 98 mol % of structural units of the general formula (IVa), (IVb) and/or (IVc).

17. The solid composition according to claim 15, wherein the polymer has a composition selected from:
10 to 70 mol % of structural units of the general formula (I) and 30 to 90 mol % of structural units of the general formula (II), (III), (IVa), (IVb) and/or (IVc); and
5 to 90 mol % of structural units of the general formula (III) and 10 to 95 mol % of structural units of the general formula (IVa), (IVb) and/or (IVc).

18. The solid composition according to any of claims 11 to 17 claim 14, wherein the weight ratio of polymer to calcium silicate hydrate is from 5:1 to 1:3.

19. Building material mixture comprising a composition according to claim 13 and (a) (portland) cement, slag sand, fly ash, silica dust, metakaolin, natural pozzolans, burnt oil shale, calcium aluminate cement, or mixtures of two or more of these components, or (b) (portland) cement and calcium sulphate-based binder.

20. Method of utilizing the composition according to claim 13 as a setting accelerator in building material mixtures comprising (portland) cement, slag sand, fly ash, silica dust, metakaolin, natural pozzolans, burnt oil shale, calcium aluminate cement or mixtures of two or more of these components, or in building material mixtures comprising (portland) cement and calcium sulphate-based binder, or in building material mixtures comprising essentially (portland) cement as a hydraulic binder.

21. Method of utilizing Usc of the composition according to claim 13 as a grinding aid in the production of (portland) cement.

22. Method of utilizing the composition according to claim 14 as a grinding aid in the production of (portland) cement.

23. Method of utilizing the composition according to claim 14 as a setting accelerator in building material mixtures comprising (portland) cement, slag sand, fly ash, silica dust, metakaolin, natural pozzolans, burnt oil shale, calcium aluminate cement or mixtures of two or more of these components, or in building material mixtures comprising (portland) cement and calcium sulphate-based binder, or in building material mixtures comprising essentially (portland) cement as a hydraulic binder.

24. Building material mixture comprising a composition according to claim 14 and
(a) (portland) cement, slag sand, fly ash, silica dust, metakaolin, natural pozzolans, burnt oil shale, calcium aluminate cement, or mixtures of two or more of these components, or
(b) (portland) cement and calcium sulphate-based binder.
